(19) United States
(12) Patent Application Publication
(10) Pub. No.: US 2003/0012390 A1
(43) Pub. Date: Jan. 16, 2003

(54) Cochlear implant

(76) Inventor: Albert Franks, Middlesex (GB)

Correspondence Address: Thomas N Young, Young & Basile, Suite 624, 3001 West Big Beaver Road, Troy, MI, 48084, US

(21) Appl. No.: 10/203,990

(22) PCT Filed: Feb. 15, 2001
(86) PCT No.: PCT/GB01/00602

(30) Foreign Application Priority Data
Feb. 16, 2000 (GB) 0003556.8

(51) Int. Cl. H04R 3/00

(52) U.S. Cl. 381/114

(57) ABSTRACT

The present invention provides a vibration detector device (1) suitable for use as a cochlear implant (12). The detector device (1) comprises a substrate (2) formed and arranged for supporting a plurality of resonator bars (4). The resonator bars (4) are of a uniform length and are supported at each end (6, 8) by the substrate material (2). Each of the resonator bars (4) has a distinct resonant frequency characteristic and is arranged with a piezoelectric generator to generate a signal in response to receiving a vibration which causes the resonator bar (4) to vibrate at its resonant frequency.

The present invention relates to a cochlear implant, suitable for use by humans, utilising microtechnology.

The Western World and in particular the industrialised nations are experiencing a shift in demography to an extent where most countries, including the United Kingdom, have an ageing population. This ageing population has been brought about by significant improvements in health and healthcare. Whilst these improvements in health and healthcare have given rise to more persons living to older ages, certain body organs and in particular the eye and the ear, often fail with the onset of old age and thus the quality of life experienced by persons of an older age is impaired.

A major cause of deafness is degradation of the hair cells found within the cochlea. As these hairs degenerate, the ability to hear certain frequencies of sound becomes impaired and there is a loss of “sharpness” or resolution of the sound.

Cochlear implants have been developed to seek to overcome degradation of hair cells, and one type of cochlear implant that is known is that of a pre-formed electrode positioned against the inner wall of the scala tympani of the cochlea. Such known implants have approximately 22 electrodes and when it is appreciated that there are in excess of 20,000 hair cells in each cochlea it will readily be appreciated that such cochlear implants cannot provide the detail or resolution required to give useful hearing across the audio spectral range of the human. Typically the range of frequencies that the normal ear is capable of sensing is in the range of 20 Hz to 20 kHz though in practice the human ear is at its most sensitive between 2 kHz and 5 kHz. It is difficult with currently available cochlear implants to provide the resolution of hearing required by a human in an everyday environment where there is background noise. An example of such a cochlear implant is that provided under the CLARION® Trade Mark by Advanced Bionics GmbH of Germany/Advanced Bionics UK Limited of England.

Harada, Ikeuchi, Fukui and Ando in their paper Fish-Bone Structured Acoustic Sensor Toward Silicon Cochlear Systems presented as part of the SPIE Conference on Micromachined Devices and Components IV in California in September 1998 described a micro mechanical acoustic sensor modelling the basilar membrane of the human cochlea. The skeleton of the acoustic sensor is an array of resonators each of specific frequency selectivity. The mechanical structure of the sensor is designed using FEM (finite element) analysis to have a particular geometrical structure looking like a fish-bone that consists of a series of cantilever ribs extending out from a backbone (see FIG. 4 of the enclosed drawings). An acoustic wave introduced to a diaphragm placed at one end of the backbone travels in one direction along the backbone. During the passage of the acoustic wave each frequency component of the acoustic wave is delivered to the corresponding cantilever according to its resonant frequency. The mechanical vibrations of each cantilever is detected in parallel by use of piezoresistors. This system has been modelled on the actual working of the cochlea whereby sounds travelling through the external ear canal vibrate the tympanic membrane. These vibrations are transmitted to the oval window via ossicles composed of a series of three small bones in the middle ear. The basilar membrane partitions the cochlea filled with fluid into three compartments. The vibrations introduced to the cochlea cause a travelling sound wave on the basilar membrane to travel along it. Each portion of the basilar membrane resonates with specific frequencies according to its width and stiffness, varying along its whole span. The more stiff and narrow part of the basilar membrane is situated close to the oval window and can resonate with a higher frequency, while the more flexible and wider part of the basilar membrane is closer to the opposite end or basal end and can resonate with a lower frequency. The basilar membrane can thus be regarded as a mechanical filter bank having many different resonant frequencies. Each frequency component is transduced into an electric pulse train by the hair cells which is then transmitted to the central nervous system so that a person can “hear”.

If the fish-bone structure disclosed above and which is the subject of European Patent Application Publication No. EP 881477A were scaled down to fit within the cochlea it would not be a practicable basis for a cochlear implant. This is because the particular fish-bone structure (shown with respect to FIG. 4), whereby the cantilevers are mounted at one end only on a backbone, will lack the required structural integrity and dynamic stability to enable them to support themselves and to be placed within the extracellular fluid found in the cochlea i.e. there is a significant risk that the unsupported ends of each cantilever will simply curl up within this fluid thus rendering such a cochlear implant useless.

It is an object of the present invention to avoid or minimise one or more of the foregoing disadvantages.

In one respect the present invention provides a vibration wave detector comprising a receiver for receiving vibration waves to be propagated in a medium, a resonant unit having a plurality of resonators each having a fixed length and being formed and arranged dimensionally to resonate at an individual predetermined frequency, and support means for supporting, at each end, each of said resonators, and a vibration intensity detector for detecting the vibration intensity for each predetermined frequency, of each of the resonators.

In another respect the present invention provides a vibration detector suitable for use a cochlear implant for use in the human ear, which detector comprises a substrate formed and arranged for supporting a plurality of resonators, said resonators being of a uniform length and being supported at each end thereof by said substrate, each said resonator having a distinct individual predetermined resonant frequency characteristic and being formed and arranged to generate a signal in response to receiving a vibration which causes each said resonator to vibrate at its resonant frequency.

Thus with the vibration wave detector according to the first aspect of the present invention it is possible to provide a device suitable for use as a microphone and which lends itself to manufacture using technologies such as employed in silicon micromachining technology.

Moreover and according to a second aspect of the invention there is provided a vibration detector suitable for use as a cochlear implant within the human cochlea which has substantially improved structural integrity over the prior art and which is suitable for production using inter alia silicon micromachining technology.

Preferably according to either aspect of the invention said resonators of a uniform length are arranged to have a different thickness or depth so as to resonate at a said individual predetermined frequency.

The spacing apart between adjacent resonators may be identical i.e. the resonators are equidistantly spaced apart for convenience of manufacture. The spacing can though be varied according to any particular requirement. There may be provided from 20-2000, typically several hundred, preferably 50-500 resonators in a side-by-side relationship. Preferably said resonators are spaced apart parallel to each other and perpendicular to said substrate.

Preferably said vibration detector according to either aspect of the invention has a ladder type construction wherein the resonators comprise the rungs and the substrate forms the ladder sides supporting the resonators at each end.

Alternatively said resonators may be spaced apart parallel to each other albeit inclined at an angle to the substrate e.g. at 65°, thereby allowing an increase in the length of the resonators for the same overall width of the substrate. This is particularly desirable insofar as for any given material and frequency the length of the resonator is directly proportional to the square root of its depth(d). Thereby it is possible to have longer resonators and to use a thicker material and to produce a structure which has further improved structural characteristics over the prior art.

Preferably the substrate is provided at each end thereof with more or less stiff end struts formed and arranged to give the overall structure rigidity and to prevent it from collapsing.

Any suitable form of resonator may be used though preferably said resonator is in the form of an element selected from the group including active devices such as a piezoelectric element, or passive devices including a strain detecting element, a capacitive element and a piezoresistor element.

Preferably where an active device such as a piezoelectric element is used the resonators are formed and arranged so as to provide a piezoelectric output signal over the audio spectral range of from 250 Hz-8 kHz. Alternatively where passive devices are used these may be formed and arranged to provide an output over a similar audio spectral range.

Preferably the vibration detector device suitable for use as a cochlear implant has breadth and width dimension that do not exceed approximately 1 mm by 1 mm to enable it to be fed into one of the cochlear channels. Desirably the length of such a vibration detector device suitable for use as a cochlear implant should not exceed 25-30 mm again to facilitate it being fed into one of the cochlear channels.

As noted above the resonators are of a constant length but have differing thicknesses so as to provide each said distinct resonant frequency characteristic. Thus to provide resonating structures over the audio spectral range of 250 Hz-8 kHz said resonators vary in thickness linearly with frequency and preferably this thickness ranges from 0.08 μm at 250 Hz to 2.64 μm at 8 kHz for material such as polyvinyldilenefluoride (PVDF).

Preferably said resonators are in the form of a flexible piezoelectric material such as, for example, PVDF. Alternatively there may be provided resonator materials which have more or less stiff structural capabilities including DLC (diamond like carbon), silicon or diamond itself. These materials may then be coated with a piezoelectric material.

Any suitable type of substrate material may be used though preferably there is used a material which is sufficiently flexible to enable it to be inserted onto the cochlear channel. Desirably there is used a semiconductor material for the substrate. Alternatively though there may be used a plastics material with electrical circuits imprinted thereon. Desirably there may be used a “memory” material which can change its shape to allow a) manufacturing then b) plastic implantation. Preferably there is used a material such as for example, silicon, which lends itself to micromachining manufacturing techniques.

Where there is used passive elements for providing said signal there is preferably provided an amplifier means provided with auxiliary drive means such as for example a power source such as a battery to drive said amplifier means. Desirably where the vibration detector device is for use as a cochlear implant there is provided a battery suitable for implantation. Such batteries may be formed and arranged for inductive charging remotely. In common with other implantable electrical batteries, such batteries could either be replaced by surgical operator (for example every 5 years) or be charged conductively.

Various other electronic components may also be used to facilitate the realisation of the vibration detector device according to either aspect of the invention.

Further preferred features and advantages of the present invention will appear from the following detailed description given by way of an example of a preferred embodiment illustrated by the reference to the accompanying drawings in which:

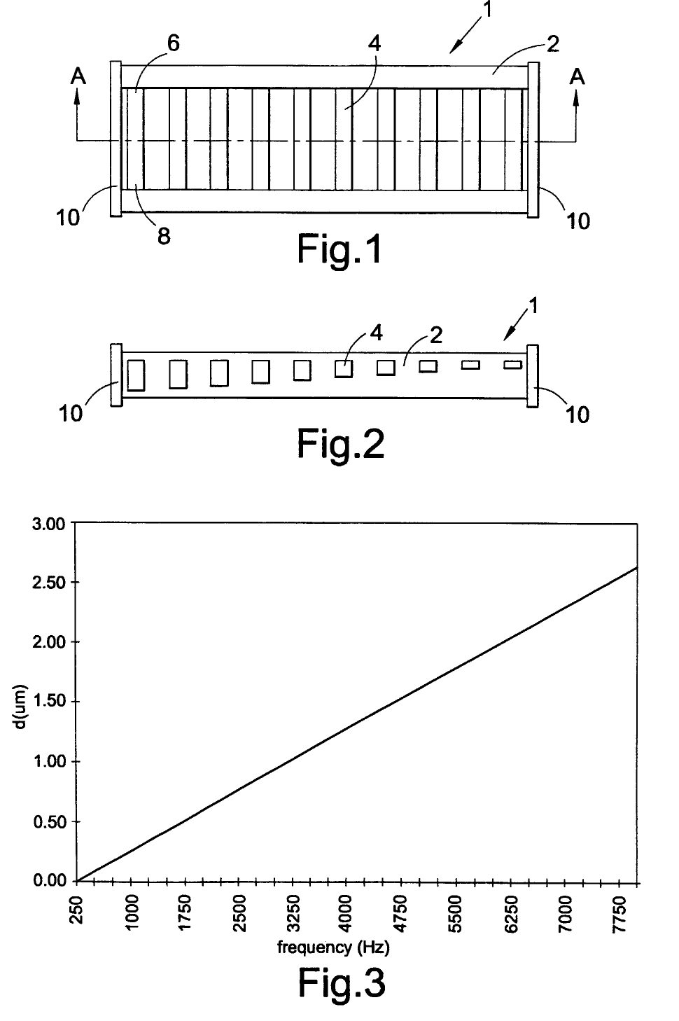

FIG. 1 is a plan view of a vibration detector device suitable for use as a cochlear implant according to the invention;

FIG. 2 is a side view in the direction of line A-A of FIG. 1;

FIG. 3 is a graph showing the relationship between frequency and resonator thickness;

FIG. 4 shows the prior art;

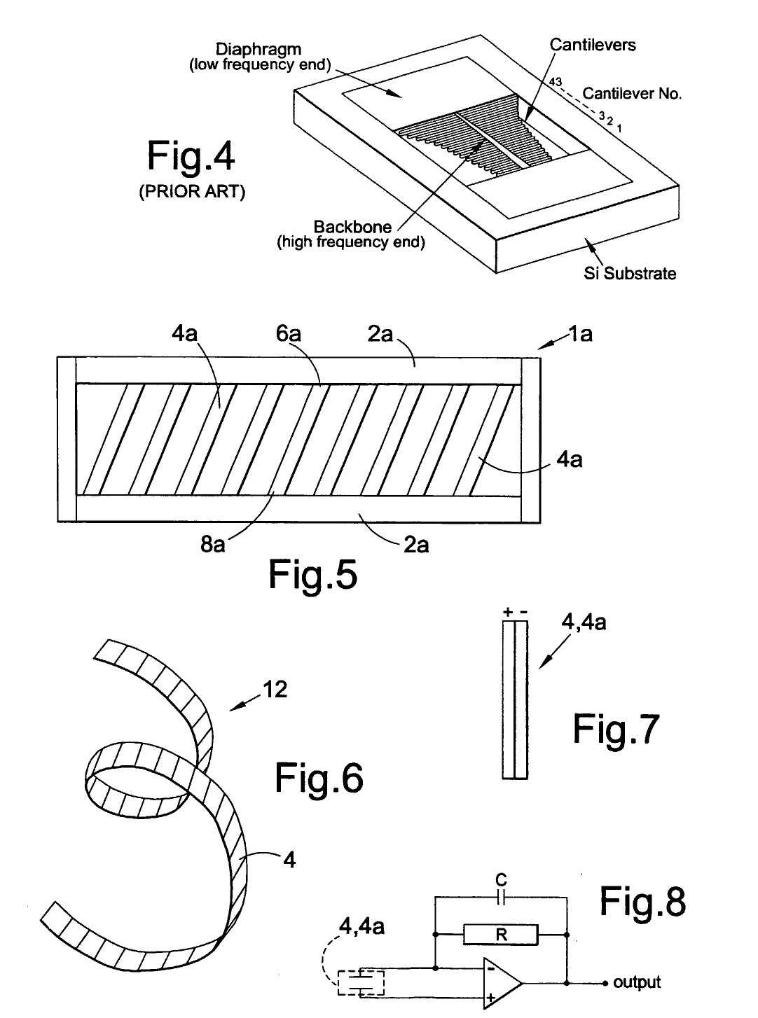

FIG. 5 shows a second embodiment of a cochlear implant generally similar to that shown in FIG. 1;

FIG. 6 shows a preferred arrangement of cochlear implant;

FIG. 7 shows a standard configuration of a bimorph for use as a piezoelectric generator in the embodiments shown in FIGS. 1, 5 or 6; and

FIG. 8 shows a generic amplifying circuit for use with a piezoelectric generator.

A vibration detector device, generally indicated by reference number 1, suitable for use as a cochlear implant, is shown in FIG. 1. The detector device comprises a substrate 2 in the form of a “ladder” arrangement formed and arranged for supporting a plurality (ten shown in FIG. 1) of resonator bars 4 (or rungs corresponding to the ladder analogy). The resonator bars 4 are of a uniform length of 600 μm and are supported at each end 6, 8 by the substrate material 2. Each of the resonator bars 4 has a distinct resonant frequency characteristic and is arranged with a piezoelectric generator (see FIG. 7) so as to generate a signal in response to receiving a vibration, in the form of a sound wave, which causes the resonator bar 4 to vibrate at its resonant frequency. The substrate 2 is supported at each end by a reinforcing strut 10.

In practice there would be a large number of bars mounted on the substrate as it will readily be appreciated that the more bars that are provided then the greater number of frequencies across the audio spectral range can be detected. For simplicity and for clarity in the attached drawings only ten such resonator bars are shown. In practice there could be used anything from 50-1000 and the numbers used are dictated solely by the manufacturing tolerances that can be applied to give the desired and required external dimensions so as to enable the device to be implanted within one of the cochlear channels.

The vibration detector shown in FIG. 1 and FIG. 2 is schematic and in practice the dimensions of the breadth and depth of the implant would not exceed approximately 1 mm wide by 1 mm depth and the length of the overall structure would not exceed 25-30 mm, again so as to facilitate feeding into one of the cochlear channels.

In order to be able to establish the resonant frequency of the bar which is supported and clamped at both ends as shown in FIG. 1 it is necessary to use the following equation:—

$$f = \frac{22.4}{2 π} \sqrt{\frac{EI}{ρ {l}^{4}}} = \frac{22.4}{2 π} \sqrt{\frac{{Edb}^{3}}{12 ρ {l}^{4}}}$$

where E=Young's modulus, d=beam depth, b=beam width, l=beam length and ρ=mass per unit length

Applying this equation to a resonating bar having a length of 600 μm of PVDF (polyvinyldilenefluoride) material where PVDF has a Young's modulus E (Gpa) of 2 and a density of 1.78×10³ (kg/m³), the following graph (FIG. 3) is given:

[image]

As shown in the above graph and in FIG. 3, the thicknesses (depth) ranges from 0.08 μm at 250 Hz to 2.64 μm at 8 kHz. It will be noted that the bar thickness varies linearly with frequency. (See also FIG. 2 which is a side view in the direction of line A-A of FIG. 1).

FIG. 5 shows a second embodiment of a cochlear implant generally similar to that described in FIG. 1 and shall be described using similar reference numerals with the suffix letter “a” attached.

The vibration detector device 1a shown in FIG. 5 comprises a substrate 2a in the form of a ladder arrangement formed and arranged for supporting a plurality of inclined resonator bars 4a (or rungs corresponding to the ladder analogy). The resonator bars 4a are of a uniform length and are supported at each end 6a, 8a by the substrate material 2a. By inclining the resonator bars 4a to the substrate 2a it is possible to provide longer resonator bars than the embodiment shown and described with reference to FIG. 1 and thereby it is possible to use a thicker material and to produce a structure which has improved structural characteristics over that shown in FIG. 1.

FIG. 6 shows preferred embodiment of a cochlear implant 12 arranged in a spiral so that it may adopt the spiral shape found within the cochlear channel of an ear. This arrangement is particularly useful as it enables a surgeon to implant such a device by pushing it in from the base of the cochlear implant and allowing it to spiral upwardly inside the cochlear channel. This particular arrangement allows the outputs from the individual resonator bars 4, where the output terminals are arranged along the length of the substrate, to stimulate, more or less directly, the nerve fibres and cells within the ear. Whilst it will be appreciated that this particular spiral design may be difficult to manufacture in a spiral, the device may be manufactured using a memory material and manufactured in a flat orientation and then when the device is placed within the ear the “memory” characteristics of the material enable the device to orientate itself within the desired spiral configuration required within the cochlear channel.

In more detail, in the case of the piezoelectric generators, each of the resonator bars 4/4a can be considered to be in the form of a bimorph configuration similar to that shown in FIG. 7. On bending as a result of receiving a sound vibration one member contracts and the other expands and thereby produces a piezoelectric signal. This piezoelectric signal may then be amplified if necessary by an amplifying circuit shown generically and schematically in FIG. 8.

Various modifications may be made to the above noted description and embodiment without departing from the scope of the present invention.

A piezoelectric material may be used in two modes in a cochlear implant. Piezoelectric materials are active materials and generate an electrical signals when deformed, for example, when set into vibration. A vibrating piezoelectric material could therefore be used either to activate the hearing nerves directly without further electrical amplification or the signal could be amplified prior to stimulating the nerves. Stimulating the nerves without additional amplification is an attractive option, but to accomplish this successfully will depend both on the electrical characteristics of the piezoelectric material and the proximity of the terminals of the implant to the nerve endings in the cochlea i.e. the closer the terminals are to the nerve endings the lower are the signal requirements. The closeness achievable will depend on the physiology of a particular ear and the skill of the cochlear implant surgeon. In a more generally applicable mode of application an amplifier may be employed to enhance the electrical signal.

For cochlear implants used hitherto, it has been established that an electrical current of approximately 1 mA is required to stimulate a hearing nerve. Because of its high impedance, a piezoelectric generator is well suited to act as a current generator. The piezoelectric generator performs as a microphone albeit for a very narrow range of frequencies only, the circuitry for amplifying the output of such microphones is well-established. The piezoelectric vibrating member has the standard bimorph configuration as shown in FIG. 7; on bending one member contracts and the other expands. A generic amplifying circuit is illustrated in FIG. 8.

Each resonator may be connected to an amplifier imprinted on the substrate. The structure would be pushed as far as possible into one of the scala of the cochlea (the scala tympani is normally used for cochlear implants) with the output terminals positioned as closely as possible to the nerve endings.

For passive resonators, the change in electrical characteristics such as resistance or capacitance resulting from the vibration, would provide the signals to be fed to the nerves via amplifiers carried by the substrate.

1. A vibration detector (1;1a) suitable for use as a cochlear implant 12 for use in the human ear, which detector (1) comprises a substrate (2;2a) formed and arranged for supporting a plurality of resonators (4;4a), said resonators (4;4a) being of a uniform length and being supported at each end (6;8;6a;8a) thereof by said substrate (2;2a), each said resonator (4;4a) having a distinct individual predetermined resonant frequency characteristic and being formed and arranged to generate a signal in response to receiving a vibration which causes each said resonator (4;4a) to vibrate at its resonant frequency.

2. A detector (1;1a) as claimed in claim 1 wherein said resonators (4;4a) have different depths and/or widths from one another such that each resonator (4;4a) has an individual distinct predetermined resonant frequency.

3. A detector (1;1a) as claimed in claim 2 wherein said different depths and/or widths vary linearly with said resonant frequency.

4. A detector (1;1a) as claimed in any one of claims 1 to 3 wherein said resonators (4;4a) are equidistantly spaced apart from one another.

5. A detector (1;1a) as claimed in any one of claims 1 to 4 provided with from 20 to 2000 resonators (4;4a) in a side-by-side relationship.

6. A detector (1;1a) as claimed in any one of claims 1 to 4 provided with from 50 to 500 resonators (4;4a) in a side-by-side relationship.

7. A detector (1) as claimed in any one of claims 1 to 6 wherein said resonators (4) are arranged to be spaced apart parallel to each other and perpendicular to said substrate (2) in a ladder-type construction.

8. A detector (1a) as claimed in any one of claims 1 to 6 wherein said resonators (4a) are inclined at a non-perpendicular angle to the substrate (2a) thereby allowing an increase in the length of the resonators (4a) for the same overall width of the substrate (2).

9. A detector (1;1a) as claimed in any one of claims 1 to 8 wherein the substrate (2;2a) is provided at each end thereof with more or less stiff end struts (10;10a) formed and arranged to give the overall structure rigidity and to prevent the detector from collapsing in use thereof.

10. A detector (1;1a) as claimed in any one of claims 1 to 9 wherein said resonator (4;4a) is in the form of an active device in the form of a piezoelectric element.

11. A detector (1;1a) as claimed in claim 10 wherein said piezoelectric element is formed and arranged to provide a piezoelectric signal over the audio spectral range of from 250 Hz to 8 kHz.

12. A detector (1;1a) as claimed in claim 10 or 11 wherein said resonators (4;4a) are formed from material selected from the group including a flexible piezoelectric material; diamond like carbon; silicon; silicon coated with a piezoelectric material; diamond; and diamond coated with a piezoelectric material.

13. A detector (1;1a) as claimed in claim 12 wherein said piezoelectric material is polyvinylidene fluoride.

14. A detector (1;1a) as claimed in any one of claims 1 to 10 wherein said resonator (4;4a) is in the form of a passive device selected from the group including a strain detecting element, a capacitive element and a piezoresistor element.

15. A detector (1;1a) as claimed in claim 14 wherein said passive device is formed and arranged to provide an output signal over an audio spectral range of from 250 Hz to 8 kHz.

16. A detector (1;1a) as claimed in claim 14 or claim 15 wherein said passive device further comprises an amplifier means and an auxiliary drive means to drive said amplifier means.

17. A detector (1;1a) as claimed in claim 16 wherein said auxiliary drive means is a battery.

18. A detector (1;1a) as claimed in any one of claims 1 to 17 wherein the substrate (2;2a) is formed from a material which is sufficiently flexible to enable it to be inserted into a cochlear channel wherein said material is selected from the group consisting of a semiconductor material, a plastics material with electrical circuits imprinted thereon and a memory metal.

19. A detector (1;1a) as claimed in anyone of claims 1 to 18 wherein the substrate (2;2a) is formed from a semiconductor material comprising silicon.

20. A detector (1;1a) as claimed in any one of claims 1 to 19 arranged, at least in use in a cochlear channel, in a spiral or helical shape.

21. A detector 1;1a as claimed in any one of claims 1 to 20 wherein said resonant frequency is derived from the following relationship:
$$Frequency ( f ) = \frac{22.4}{2 π} \sqrt{\frac{{Edb}^{3}}{12 ρ {l}^{4}}}$$
where E=Young's modulus of the material from which said resonators are formed;
d=beam depth of said resonator;
b=beam width of said resonator;
ρ=mass of resonator material per unit length; and
l=length of resonator.

22. A vibration wave detector comprising a receiver for receiving vibration waves to be propagated in a medium, a resonant unit having a plurality of resonators each having a fixed or uniform length and being formed and arranged dimensionally to resonate at an individual predetermined frequency, and support means for supporting, at each end, each of said resonators, and a vibration intensity detector for detecting the vibration intensity for each predetermined frequency, of each of the resonators.

23. A method of detecting vibration waves comprising the steps of:
a) providing a detector (1;1a) according to claim 1;
b) receiving vibration waves to be detected;
c) propagating said vibration waves onto a resonator (4;4a);
d) receiving said signal generated by said resonator (4;4a) vibrating at its characteristic frequency.

24. A cochlear implant (12) including a vibration detector (1) according to any one of claims 1 to 21.
